(19) United States
(12) Patent Application Publication
(10) Pub. No.: US 2012/0197763 A1
(43) Pub. Date: Aug. 2, 2012

(54) SYSTEM AND PROCESS FOR IDENTIFYING MERCHANDISE IN A VIDEO

(76) Inventor: Michael Moreira, Baldwin, NY (US)

(21) Appl. No.: 13/016,927

(22) Filed: Jan. 28, 2011

(51) Int. Cl. G06Q 30/00; G06F 17/30

(52) U.S. Cl. 705/27.1; 707/770; 707/E17.014

(57) ABSTRACT

One embodiment of the invention relates to a computerized process for matching an object in a video with information. This process can comprise the steps of watching a video, selecting an object from the video, inserting the object into a search field, and conducting a search in a database to find additional information. Once this additional information is found, the process results in matching the object from the video with at least one data object from the additional information. In addition once this data is matched, the process can proceed to presenting the at least one data object from the additional information on a screen. Another process can be a computerized process which can comprise the steps of uploading at least one video into a database, uploading at least one separate image into the database, uploading text data into the database, and matching the at least one video, the at least one separate image and the text data in the database.

### BACKGROUND OF THE INVENTION

One embodiment of the invention relates to a system and process for identifying merchandise in a video. Other types of computer implemented document image management systems are known in the art. For example U.S. Pat. No. 6,718,334 to Han which discloses a computer based document management system which combines a digital computer and video display. In addition U.S. Pat. No. 7,680,324 to Boncyk et al which issued on Mar. 16, 2010 discloses the use of an image derived information as search criteria for internet and other search engines. The present invention differs from the above patents, nevertheless, disclosure of these patents is hereby incorporated herein by reference.

Companies wishing to promote their products via a video medium rely on direct advertising through an actual commercials to promote their products. These same companies may also rely on product placement of their products into movies as well as into other forms of media. The use of product placement allows companies to subtly advertise their products while being placed in video content that is being displayed that is not presented as atypical advertisement. However, viewers of this video content may not know how to purchase or access more information about the products related to this advertisement. Therefore, there is a need for a system and process for identifying products presented in a video wherein this system and process allows the viewer to identify, search for, and access additional information about a product or to purchase the actual product.

### SUMMARY OF THE INVENTION

One embodiment of the invention relates to a computerized process for matching an object in a video with information. This process can comprise the steps of watching a video, selecting an object from the video, inserting the object into a search field, and conducting a search in a database to find additional information. Once this additional information is found, the process results in matching the object from the video with at least one data object from the additional information. In addition once this data is matched, the process can proceed to presenting the at least one data object from the additional information on a screen.

Another process can be a computerized process which can comprise the steps of uploading at least one video into a database, uploading at least one separate image into the database, uploading text data into the database, and matching the at least one video, the at least one separate image and the text data in the database.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG.1 is a first overview flow chart which follows three basic progressions outlined in FIGS. 3-4;

FIG. 2 is an example of a system for use with FIGS. 1-7;

FIG. 3 is a flow chart for a one process for searching for video data;

FIG. 4 is a flow chart for another process for searching for video data;

FIG. 5 is another flow chart for another process for searching for video data;

FIG. 6A is a schematic layout of a display screen using any one of the search processes of FIGS. 1, 3, 4, and 5;

FIG. 6B is a schematic layout of a display screen using any one of the search process of FIGS. 1, 3, 4 and 5;

FIG. 7 is a schematic layout of a display screen for purchasing objects found on the screen of FIG. 6.

### DETAILED DESCRIPTION

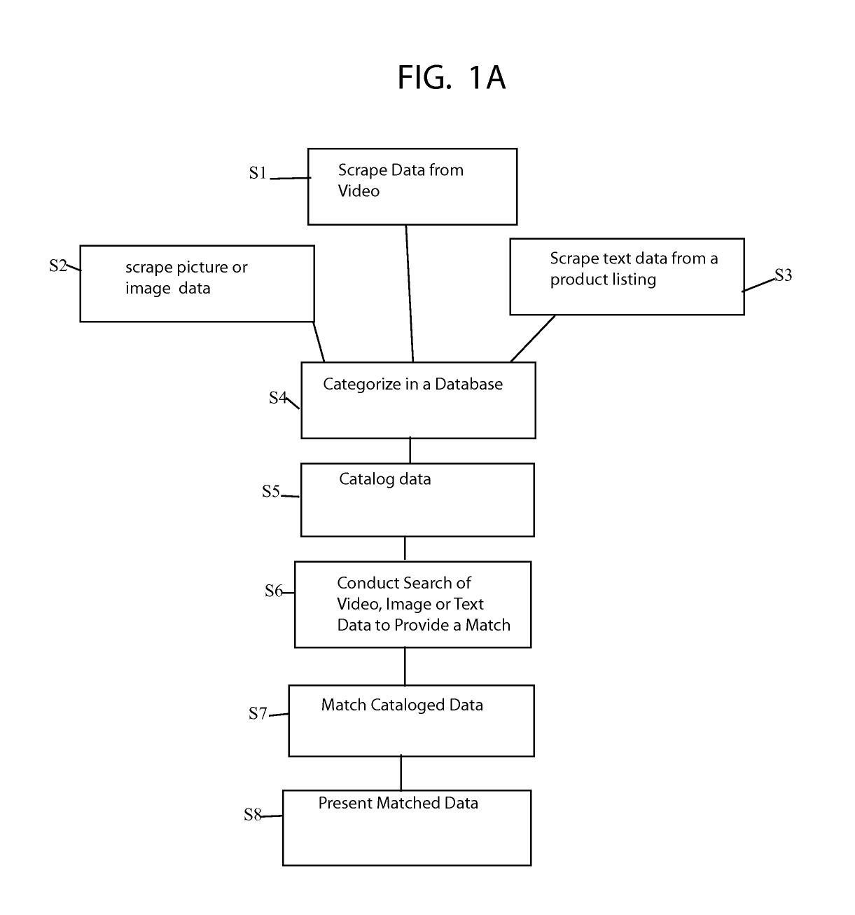

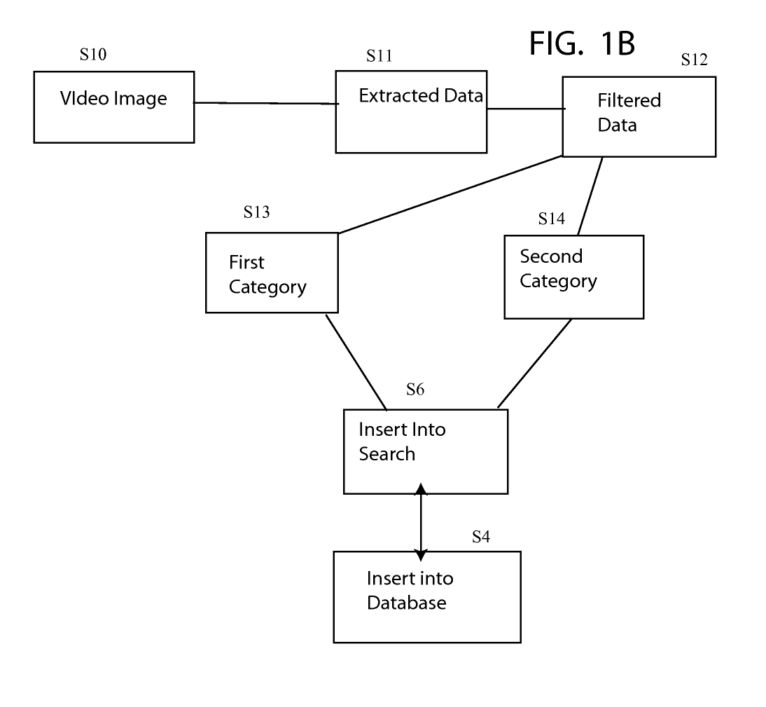

Referring in detail to the drawings, FIG. 1A is a flow chart of an overview process which shows in step S1 data is scraped from a video. In this step, this scraping can be in the form of lifting image data from the video. In at least one embodiment, this image data is manually scraped by a user, wherein the user manually selects this data using a selection device such as a computer mouse, wherein the mouse is used to select an area on the video, to select this video image data. Alternatively, this image data can be automatically scraped wherein the mouse would select a particular point on a screen of this video and would then automatically determine based upon differences in shape and outline separate object components inside the image and then automatically outline these separate object components.

Each image which can be taken from a video such as a MPEG video comprises a plurality or a series of pixels which can be used to render the image. The information that is taken from the image can be any relevant information about the image including this pixel information, taken from the entire image, a portion of the image, or strip out particular information relating to the image. For example, as disclosed in U.S. Pat. No. 7,680,324, the disclosure of which is hereby incorporated herein by reference, the image could include text rendering which could be determined from the image and then used as a search term for that image.

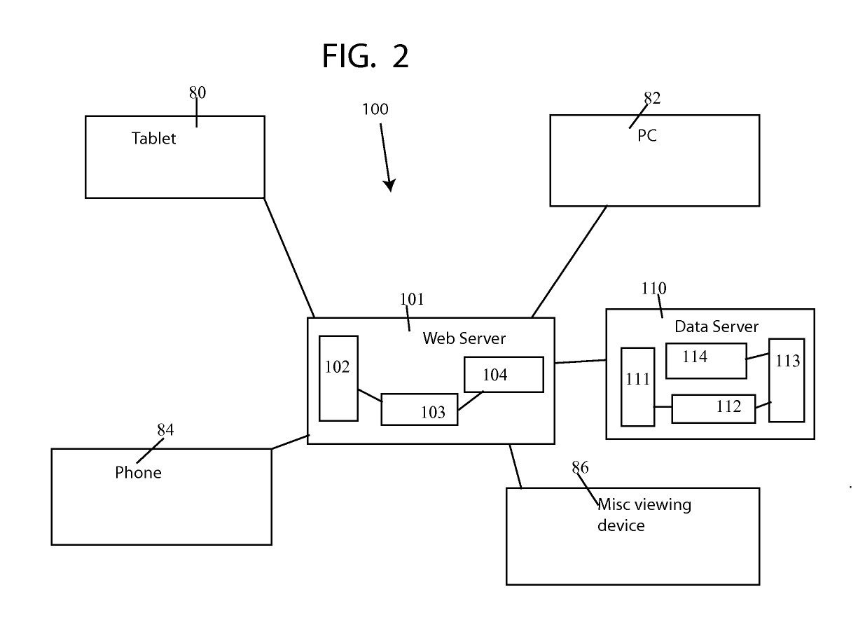

While step S1 includes scraping image data from a video, step S2 includes scraping picture image data, while step S3 includes scraping text data from a product listing. In each one of these steps, this information is then further derived in the form of bits using processor 102 and then either cataloged in a database, or stored in RAM (random access memory) temporarily for later searching. For example, in step S4 this image can be categorized in a database such as on a database 114 stored on a drive or memory 113 in a server such as data server 110 shown in FIG. 2. Alternatively, this data can be input into a search engine as shown in step S6, which will be discussed below.

If this information is categorized in a database, such as cataloged as an original image file, it is stored in a discrete location in the database, such that any other related information can be simultaneously or subsequently matched with this data. Once this information is cataloged, it can be then used as a search term and used to conduct a search such as provided in step S6. Examples of technology used to conduct an image search are Google® Goggles®, Google® Images or other technology such as image searching technology disclosed in U.S. Pat. No. 7,680,324. In addition other websites such as Tineye® which is found at www.tineye.com or Picsearch® found at www.picsearch.com can be used to search for images as well. Essentially with this type technology the bitmap or other visual data referencing each image on file in a database is stored in a database. When an image for searching is uploaded, information about that image is transformed into digital data to be matched with a catalogued image in the database. Based upon how closely these images match, then this results in the order for the search.

Once this information is searched, any additional information relating to this image data can be matched in step S7 into the database such as database 114 to create an associated list or relational database which includes all related search terms or identifying information relating to this data. Next, in step S8 this information can be presented to a user as a result of a search on a separate display screen or uploaded to a region adjacent to the video image. This information relating to the search would be in the form of a hypertext link which allows a user to access this additional information.

Steps S1 and S2 are shown in greater detail in FIG. 1B.

For example, there is shown a flow chart for obtaining data relating to this image. In this case in step S10, a video image or an actual static image is captured as described above. Next, in step S11, information from this captured image is extracted in the form of bits based upon the pixels of the image. Next, in step S12 this data is filtered or extracted such that a user can selectively control how much or what kind of data is extracted. Next, in steps S13 and S14 this information can be optionally categorized into at least two categories such as pure image data vs. text data, based upon colors, shapes etc. Next, this information can be inserted into a search such as shown in step S6 or in step S4. The process shown in FIG. 1B is shown as one example for extraction of information relating to image information from a video. Other possible processes can also be conducted to achieve the same goal.

FIG. 2 is a schematic block diagram of a system 100 which can be used to conduct the process as shown in FIGS. 1A, 1B, and 3-5.

For example, this system includes a server 101 which can be in the form of a web server, which includes at least one processor 102, at least one memory such as RAM 103, and at least one storage device such as a drive or memory 104.

Server 101 can be any type of server known in the art. In addition, there is also disclosed a plurality of peripheral devices such as a tablet computing device 80, a personal computer 82, a phone such as a smart phone 84, or any other type of miscellaneous viewing device 86.

Server 101 is in communication with data server 110 which has a processor 111, a memory or RAM 112, a storage device such as a hard drive 113, and a database 114.

These different components work together to form the system 100, wherein processor 102 of server 101, can be in the form of a single processor on a single server or a plurality of processors on a single server or a plurality of processors with a plurality of servers in a cloud configuration.

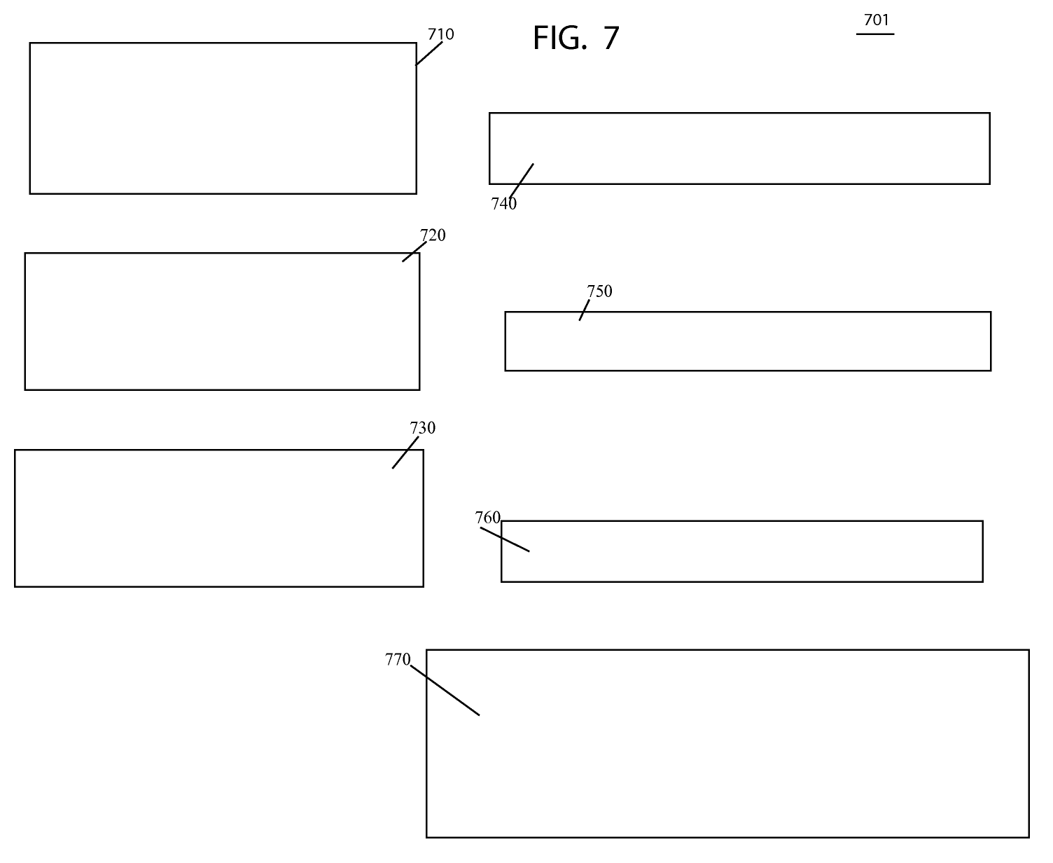

Processor 102 is configured to perform, organize, and/or control the steps shown in FIGS. 1A, 1B, and 3-6 and also configured to control or assist in the functions of a webpage shown in FIG. 7. In addition, the component configuration of server 101 comprising processor 102, memory 103, and storage 104 can also be similar or the same as the component configuration of tablet 80, PC 82, phone 84, and miscellaneous viewing device 86.

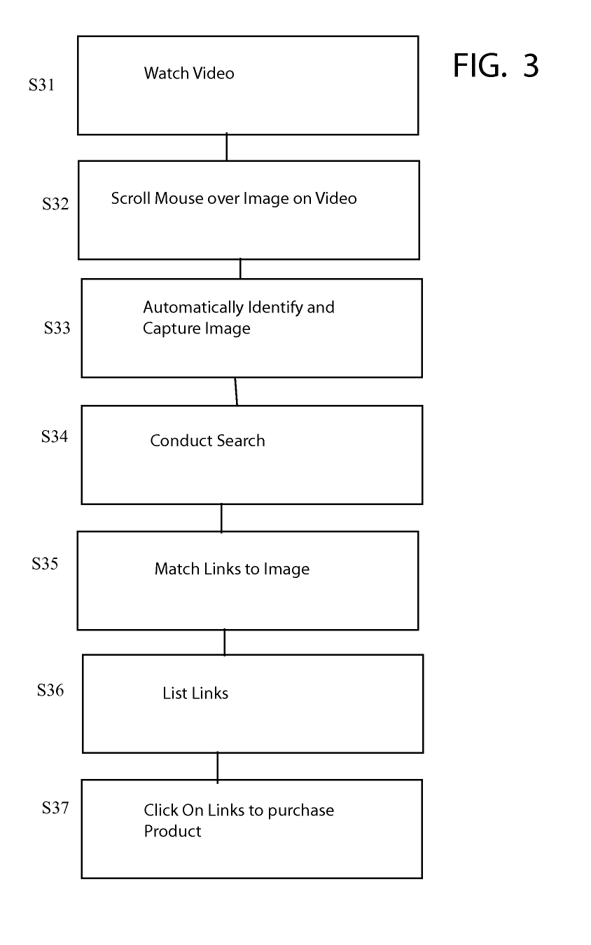

FIG. 3 discloses a series of steps S31-S37 which provide an example for a user to go from viewing a video to purchasing objects comprising goods or merchandise relating to that video. This series of steps is similar to the process detailed in FIG. 1A.

For example, in step S31, a user would watch a video such as a streaming video through a computer network. In this case, the streaming video could be broadcast by server 101 and downloaded or streamed to a remote device such as any one of tablet 80, PC 82, phone 84, or miscellaneous device 86.

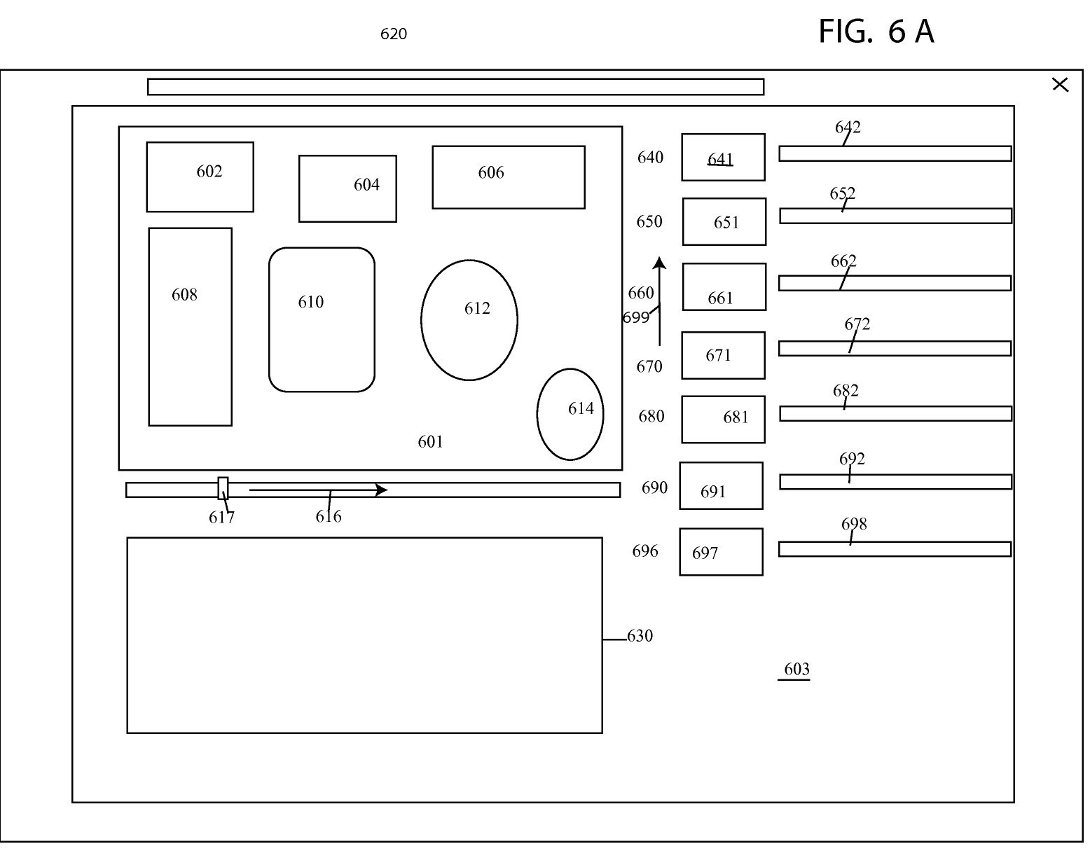

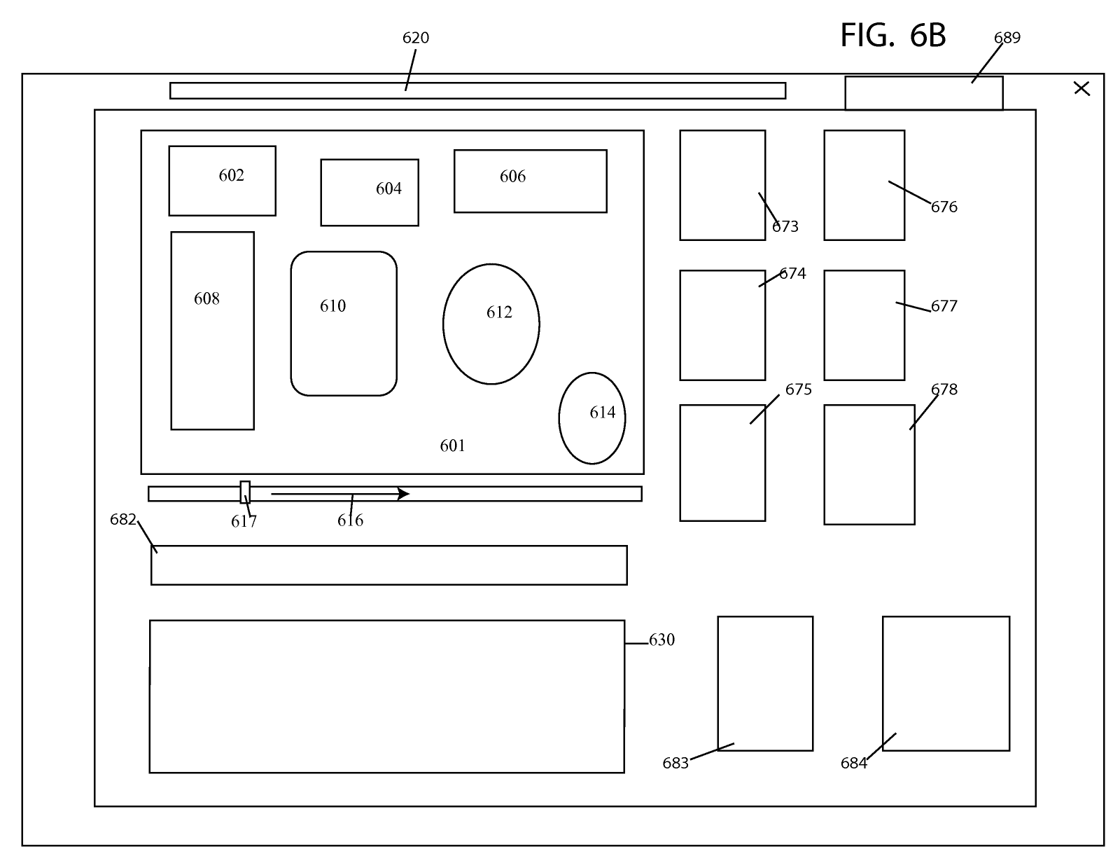

In step S32, a user could scroll his or her mouse over an image on the video such as any one of images 602, 604, 606, 608, 610 612 or 614 shown in video screen 601 in FIG. 6A and 6B.

In step S33, a user could automatically identify and capture this image. The user would do this by clicking on the image in the video screen 601 wherein the video could automatically pause and then the image that was clicked could automatically be selected using video selection or image extraction technology. For example Adobe® has a quick selection tool array which can be used to automatically select portions of an image from a still frame picture or gallery. Examples of these quick selection tools would comprise a marquee tool which allows a user to make a selection based upon a particular shape such as a square, rectangle, or circle; a move tool which allows a user to move selected images; a lasso hook which allows a user to make freehand polygonal selections either based upon straight edged selections or magnetic snap to selections; a quick selection tool which allows a user to paint a selection using an adjustable round tip brush, or a magic wand tool which allows a user to select similarly colored areas of an image. These tools could be provided in a tool kit on the web screen thereby enabling a user to select the portion of the image that the user wanted.

Once the image is captured, the information from the image can be extracted as shown in FIG. 1B, wherein this information can then be used to conduct a search in step S34. Next, once the search has been conducted, in step S35, links are matched to the image and in step S36, these links are listed adjacent to the video or image such as shown via listings 640, 650, 660, 670,680,690 and 696 which have associated images 641, 651, 661, 671, 681, 691, and 697 along with associated http links 642,652, 662, 672, 682, 692, and 698 as seen in FIG. 6A.

Next, a user can click on a link in step S37 to purchase a product. This link could move that user to a purchasing screen which could open as a separate window or tab and allow the user to find out more information about the product and then purchase the product. FIG. 7 shows an example of a purchasing screen which allows a user to purchase one or more products associated with this image. For example, FIG. 7 discloses a web page 701 which includes series of boxes representative of different objects on a web screen wherein these boxes 710, 720, 730, represent information to be purchased, and associated price information 740, 750, and 760, which can then be imported into a cart 770 for checkout.

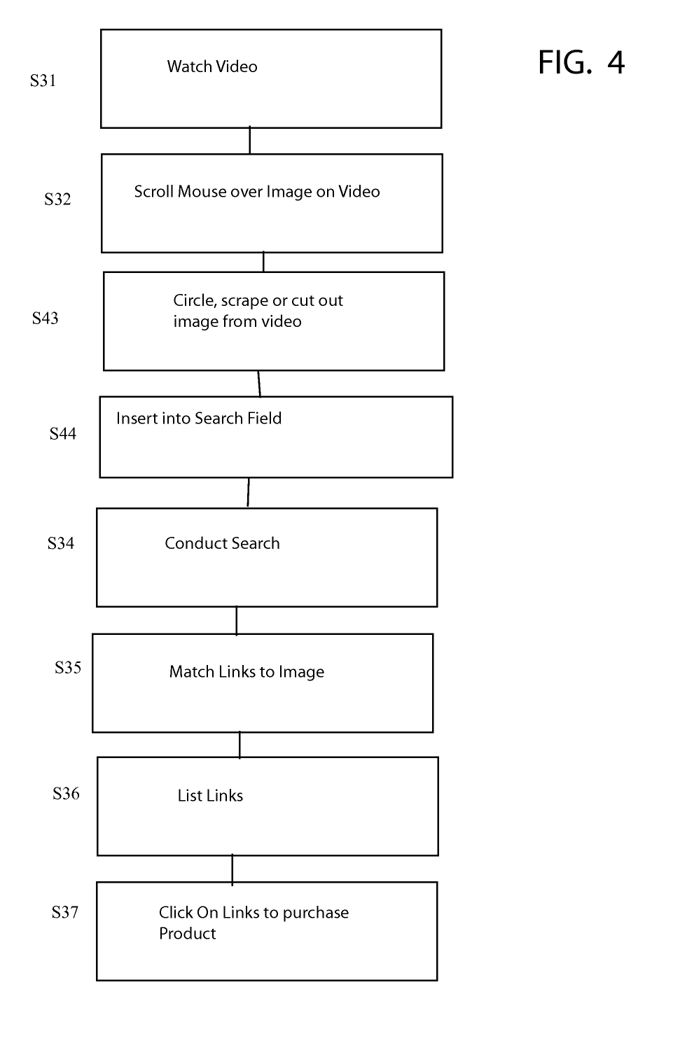

FIG. 4 discloses a modified version of the process wherein the process proceeds from step S31, to step S32, and then on to step S43 which allows a user to individually select an object from an image using the above tools described in FIG. 3. For example, the user could use the marquee tool to make a rectangular or circular or elliptical shape to select a portion of an image for extraction for searching. Next, in step S43, the user could then copy or cut this extracted image and then place it into a search field, in step S44. Once this information is in the search field it is used to conduct a search such as shown in step S34. The system including processor 102 could then proceed through the steps S35-S37 as described above.

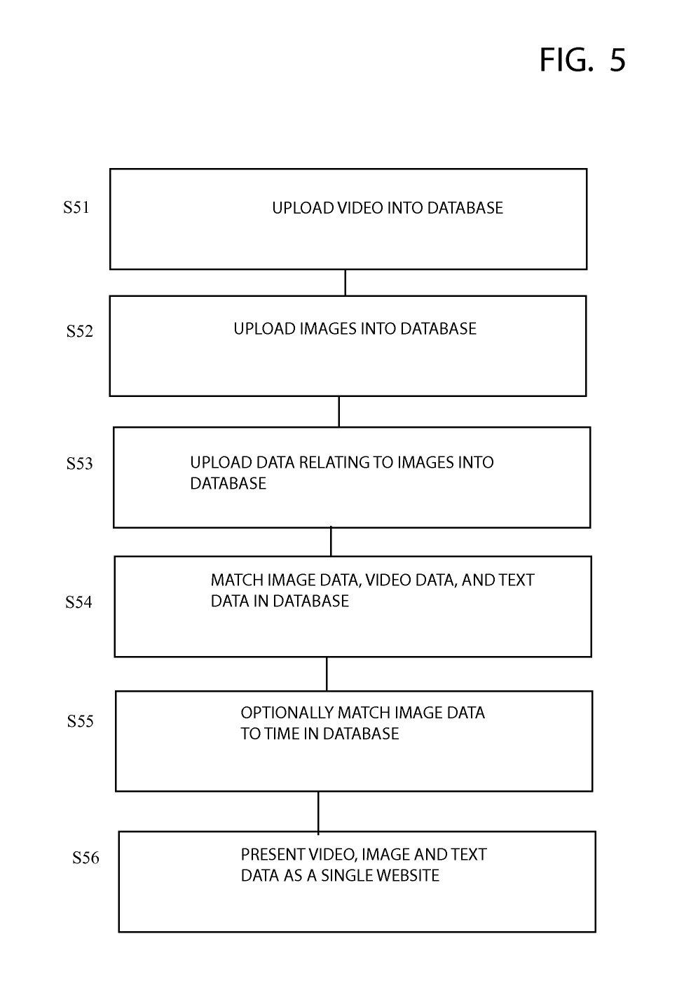

FIG. 5 shows an alternative process wherein a user could automatically provide information relating to images or objects in a video as that video is playing. For example, in this process, in step S51, a user could upload a video into a database. At this time, the user could be prompted to enter information about objects in the video. The user can then input into the database, a copy of an image which appears in the video as shown in step S52. Next, the use could also input additional information such as text information in step S53. Next, in step S54 the user would match image data, video data, and text data in a database so that as the video was playing this information could appear next to the video. An example of this feature is shown in FIG. 6A which shows screen 603 wherein a video 601 is being shown and the additional information shown in blocks 630, 640, 650, 660, 670, 680, 690, and 696 is displayed adjacent to this video 601.

Next, in step S55 a user can optionally match the image data to a time clock or time period associated with the video. This allows the information blocks 640, 650, 660, 670, 680, 690 and 696 associated with the video to be scrolled on screen 603 as shown by scrolling arrow 699.

Next, in step S56, this information is then presented together on a website as shown in screen 603 in FIG. 6A.

FIG. 6A shows a web screen or site 603 which can comprise a standard website for displaying a video but which has been improved by providing additional links as disclosed below. In this view, a video which can be downloaded, or saved on a users device, or streamed is shown in video screen 601, wherein this video can include different image objects 602, 604, 606, 608, 610, 612, and 614. This different image objects can form discrete image objects which can be selected using the selection tools described above relating to the steps outlined in FIGS. 3, 4 and 5. Disposed adjacent to this video screen or embedded in this video screen is a scroll bar 616 which allows a user to control the progression of the video shown. This scroll bar allows an indicator to move or slide based upon a time progression as is known in the art.

There is also a URL input prompt or text box 620 which allows a user to input a webpage or http link or identifies to the user the existing page on a screen.

In addition, disposed adjacent to this video section 601 is another information section or block 630 which can be used to display additional information about the video or related to the video. In addition, as discussed above, there are information blocks 640, 650, 660, 670, 680, 690 and 696 which are disposed adjacent to the video screen 601.

Information section or block 630 can be an advertising section which displays an advertisement associated with the links associated with information blocks 640, 650, 660, 670, 680, 690 and 696. Therefore, the system can receive revenue from paid advertisements which are associated with these links beforehand.

For example if a video showed a particular object such as a garment such as a sweater, the search could pull up links associated with that sweater based upon an image search and then provide links associated with a sweater that looked like the sweater in the image. In addition, advertisements which are associated with these links could then be displayed within block 630.

FIG. 6B is a different embodiment of a web page, wherein with this web page there are additional sections, such as section 682 which is configured as a catalog of products or an index of these products that are shown in a video. In addition, additional sections 673 to 675 are configured as advertising sections which are configured as sections for advertisements relating to the products being shown in the video. In this case, as these products are shown in these videos, the advertisements are presented alongside these advertisements so that they are shown simultaneous with the video. There is also a listing of additional blocks which relate to blocks 676 to 678 wherein these blocks relate to similar videos that the viewers have watched.

In this web screen there is also a search field 689 which allow a user to browse or search for videos. Therefore, with this design, a user could insert a series of words to be used in a Boolean search to allow a user to search for these additional videos.

FIG. 7 is another screen which as described above is a purchase screen for purchasing objects relating to information blocks 640, 650, 660, 670, 680, 690, and 696.

This purchase screen includes elements or information blocks 710, 720, 730, 740, 750, 760 and 770 which can be used to form a purchase screen as disclosed above.

With this design, a user could navigate to this screen by selecting one of the fields shown in FIG. 6B such as field 678 which is an advertisement. Therefore, a person could select this advertisement in field 678 and then be automatically navigated to new screen 701 which would allow the person to purchase this product.

Once the person has arrived at screen 701, that person could then navigate through this screen to select one of the following elements or information blocks 710, 720, 730, 740, 750, 760, and 770 to selectively select an article to purchase. For example block 710 could be the written information about the article. Block 720 could be the photograph or artistic depiction of the article. Block 730 could be the shipping information relating to the product to be purchased. In addition, block 740 relates to the price information. Block 750 relates to the tax to be applied to the purchase. Block 760 relates to the total amount to be paid, while block 770 is the purchase button to purchase the product.

Essentially, this system and process allows for the receipt of information relating to a produce embedded in a video, and the handling of this information so that a user reviewing a video would have relatively easy access to this product information in the video and then use this product information to purchase a product. The basic visual data taken from the screen could be used for a visual search to allow the user to more easily find this information. Alternatively, if this data is directly input into a database, this data could be used in a search and then transformed into a plurality of web links or hyper-links to direct a user towards either finding out more about the product or even purchasing this product.

It is believed that this information is useful because it allows a user to start from viewing a video, to actually purchasing a product with a minimal amount of work in finding the actual product.

Therefore, this system is configured to allow a user to start from a video and then to learn more about a product in this video and then easily move to a purchase screen so the user could purchase a product.

Accordingly, while a few embodiments of the present invention have been shown and described, it is to be understood that many changes and modifications may be made thereunto without departing from the spirit and scope of the invention as defined in the appended claims.

What is claimed is:

1. A computerized process for matching an object in a video with information, the process comprising the steps of:
a) watching a video on a screen;
b) selecting an object from said video;
c) inserting said object into a search field;
d) conducting a search in a database to find additional information;
e) matching said object from said video with at least one data object from said additional information; and
f) presenting said at least one data object from said additional information on a screen.

2. The computerized process as in claim 1, wherein said process is performed using a processor which is configured to perform at least one function for performing at least one step, and wherein the process further comprises the step of deriving data from said object in said video by using said processor.

3. The computerized process as in claim 2, wherein said process is performed using a memory which functions in combination with said processor to perform said at least one step.

4. The computerized process as in claim 3, wherein said step of watching a video comprises watching a video over a computer network wherein said video comprises a plurality of bits processed by said processor.

5. The computerized process as in claim 3, wherein said step of selecting an object from said video comprises selecting at least one image from said video.

6. The computerized process as in claim 5, wherein said step of selecting at least one image comprises manually selecting said at least one image by selecting an area occupied by said at least one image, and then scraping said at least one area from said video.

7. The computerized process as in claim 5, wherein said step of selecting at least one image comprises automatically selecting via said processor said at least one image by using said processor to perform the following steps:
recognizing at least one outline of said image;
selecting said image based upon said at least on outline of said image.

8. The computerized process as in claim 5, wherein said step of inserting an object into said search field comprises inserting said selected at least one image into said search field.

9. The computerized process as in claim 8, wherein said step of conducting a search comprises searching via at least one database across a computer network to match said selected at least one image with at least one data object on the computer network.

10. The computerized process as in claim 9, wherein said step of presenting said at least one data object comprises listing said at least one matched data object with the image on a display screen, and presenting a link to said at least one data object in a position adjacent to said video on the display screen.

11. The computerized process as in claim 10, further comprising clicking on said link to said at least one data object to navigate to an additional screen.

12. The computerized process as in claim 11, further comprising the steps of:
presenting a user with a display for purchasing an item associated with said at least one data object;
purchasing via said display an item associated with said at least one data object.

13. A computerized process comprising the steps of:
a) uploading at least one video into a computer database;
b) uploading at least one separate image into said computer database;
c) uploading text data into said computer database;
d) matching said at least one video, said at least one separate image and said text data in said computer database.

14. The computerized process as in claim 13, wherein said process is performed using a processor which is configured to perform at least one function for performing at least one step.

15. The computerized process as in claim 14, wherein said process is performed using a memory which functions in combination with said processor to perform said at least one step.

16. The computerized process as in claim 15, further comprising the step of presenting a screen comprising said at least one video, said at least one image data, and said text data.

17. The computerized process as in claim 16, further comprising the step of presenting at least one link to another screen, wherein said at least one link is associated with at least one of said at least one video, said at least one image data and said text data.

18. The computerized process as in claim 17, further comprising the step of presenting at least one screen associated with said at least one link, wherein said at least one screen presents at least one option to purchase at least one object associated with said at least one video, said at least one image data and said text data.

19. The computerized process as in claim 18, further comprising the step of purchasing said at least one object.
